(19) United States
(12) Patent Application Publication
(10) Pub. No.: US 2006/0235341 A1
(43) Pub. Date: Oct. 19, 2006

(54) Massage bar

(76) Inventor: Yuan Feng Feng, Dayard Town (TW)

Correspondence Address: Keith Kline;PRO-TECHTOR INTERNATIONAL SERVICES, 20775 Norada Court, Saratoga, CA, 95070-3013, US

(21) Appl. No.: 11/110,454

(22) Filed: Apr. 19, 2005

(51) Int. Cl. A61H 1/00

(52) U.S. Cl. 601/15; 601/70; 601/73

(57) ABSTRACT

Provided is a massage bar powered by battery or DC. The massage bar comprises a shell assembly comprising outer and inner shells having apertures, a motor unit in the inner shell and comprising an eccentric member fixedly connected to its drive shaft, and a ring fixedly connected to the eccentric member, and a needle unit projected through the shell assembly and comprising an internal IR section, a conductive shell, and an electric heating element electrically connected to DC power. Connecting the massage bar to an external AC source will activate the electric heating element to heat the conductive shell for conducting heat to the IR section and causing the IR section to emit IR through a pointed end of the needle unit into parts of the body for carrying out an acupuncture effect, and activate the motor unit and vibrate the ring and the pointed end for massage.

### BACKGROUND OF THE INVENTION

1. Field of Invention

The present invention relates to massage equipment and more particularly to a massage bar with acupuncture effect.

2. Related Art

Acupuncture as means of treating disease or relieving pain is well known in Chinese society. However, a person pierced by acupuncture may be infected with virus (e.g., AIDS) if the needle thereof is not completely cleaned after a previous use. Moreover, some people may have side effects after being treated by acupuncture. Thus, acupuncture is more or less not safe and is not suitable for all people. Hence, a need has arisen for an improved massage bar having another effect similar to acupuncture in addition to its massage effect.

### SUMMARY OF THE INVENTION

It is therefore an object of the present invention to provide a massage bar comprising a battery compartment comprising a DC power input adapted to releasably electrically connect to an AC adaptor, a switch electrically connected to the DC power input, and a space adapted to store at least one cell; a shell assembly comprising an outer shell having a plurality of apertures on its surface, and an inner shell having a plurality of apertures on its surface; a drive unit in the inner shell and comprising a DC motor, an eccentric member fixedly connected to a drive shaft of the DC motor, and a ring fixedly connected to the eccentric member; and a needle unit projected through the shell assembly and comprising a pointed end, an internal IR section, a conductive shell, and an electric heating element in the conductive shell, the electric heating element being electrically connected to the DC power input; whereby electrically connecting the massage bar to an external AC source through the DC power input and the AC adaptor and turning on the switch will activate the electric heating element to heat the conductive shell for conducting heat to the IR section and causing the IR section to emit IR through the pointed end into parts of the body for carrying out an acupuncture effect; and activate the drive unit and vibrate the ring and the pointed end for carrying out a massage effect.

In one aspect of the present invention, in response to electrically connecting the massage bar to the cell and turning on the switch, the drive unit is activated to vibrate the ring and the pointed end for carrying out a massage effect.

In another aspect of the present invention, the IR section is formed of IR magnetic stone or powder.

The above and other objects, features and advantages of the present invention will become apparent from the following detailed description taken with the accompanying drawings.

### BRIEF DESCRIPTION OF THE DRAWINGS

FIG. 1 is an exploded view of a preferred embodiment of massage bar according to the invention;

FIG. 2 is a perspective view of the assembled massage bar in FIG. 1;

FIG. 3 is a view similar to FIG. 2 with a battery cover separated for inserting a cell into a battery compartment;

FIG. 4 is a sectional view of needle unit;

FIG. 5 is a front view of drive unit in its operating state; and

FIGS. 6 and 7 are environmental views for illustrating operations of three massage bars (i.e., battery operated case) and a single massage bar (i.e., external power operated case) contacting parts of the body respectively.

### DETAILED DESCRIPTION OF THE INVENTION

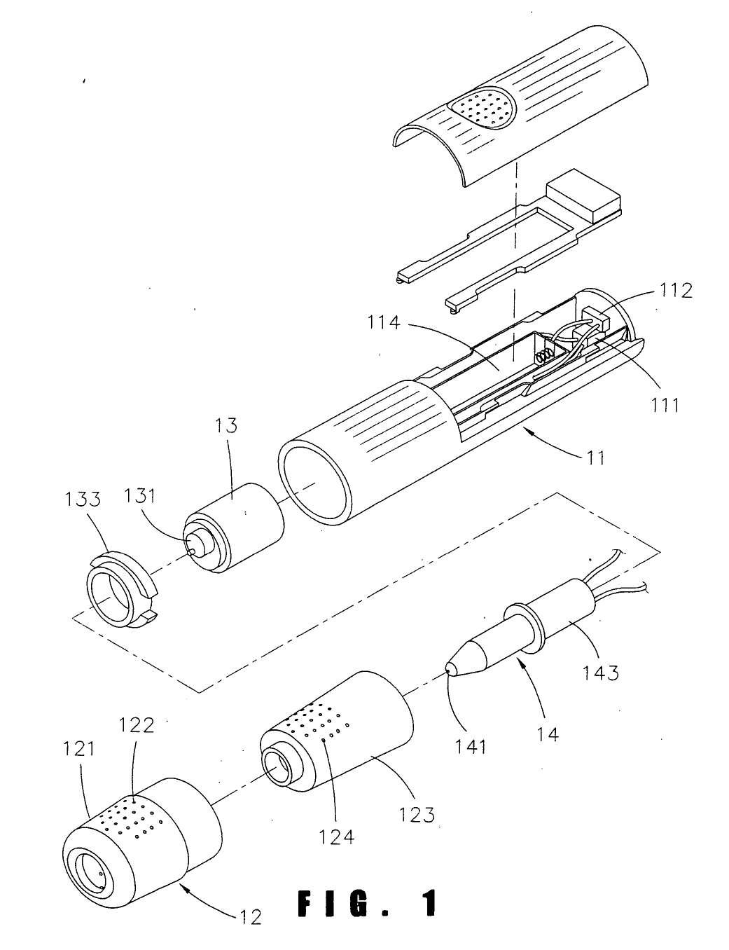

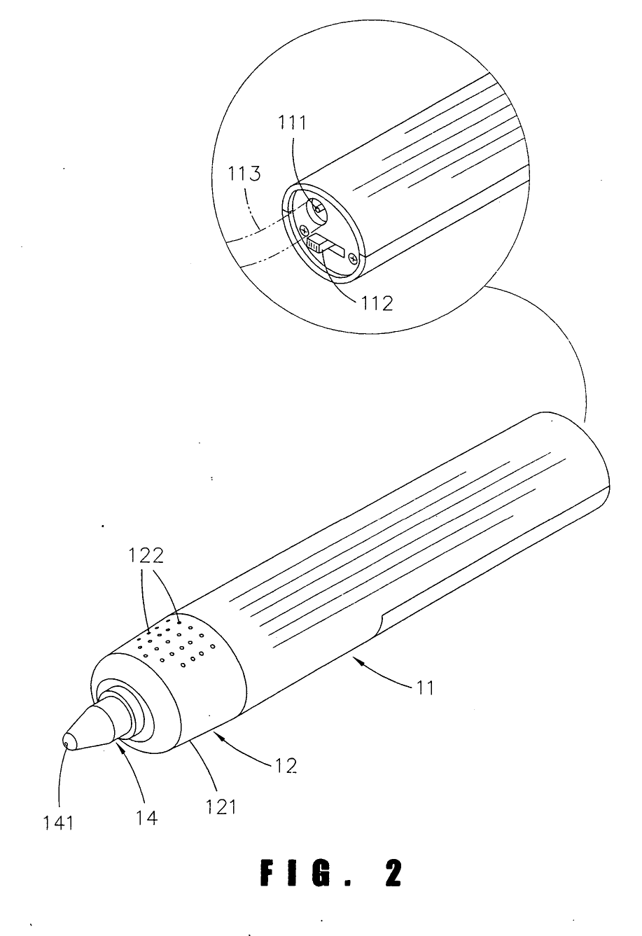

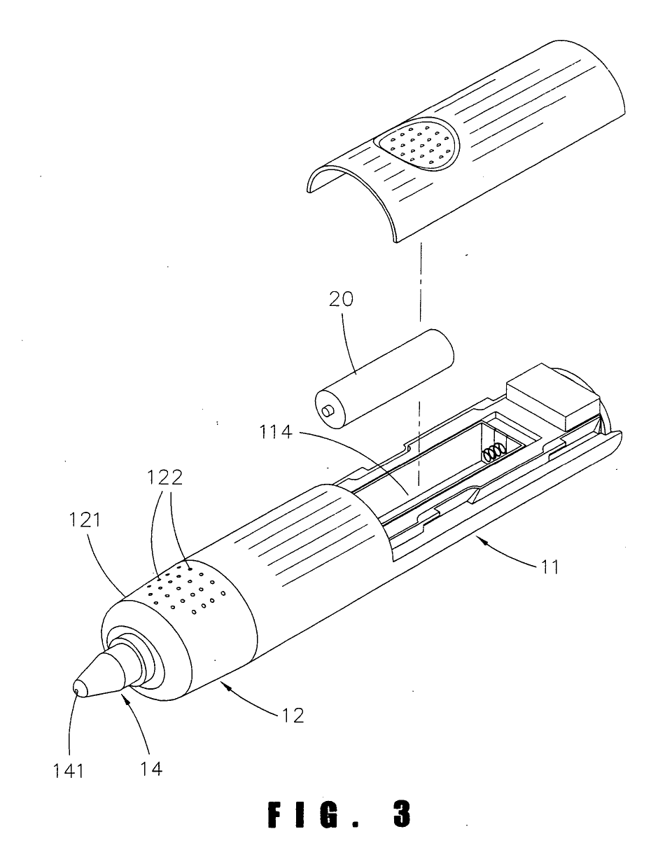

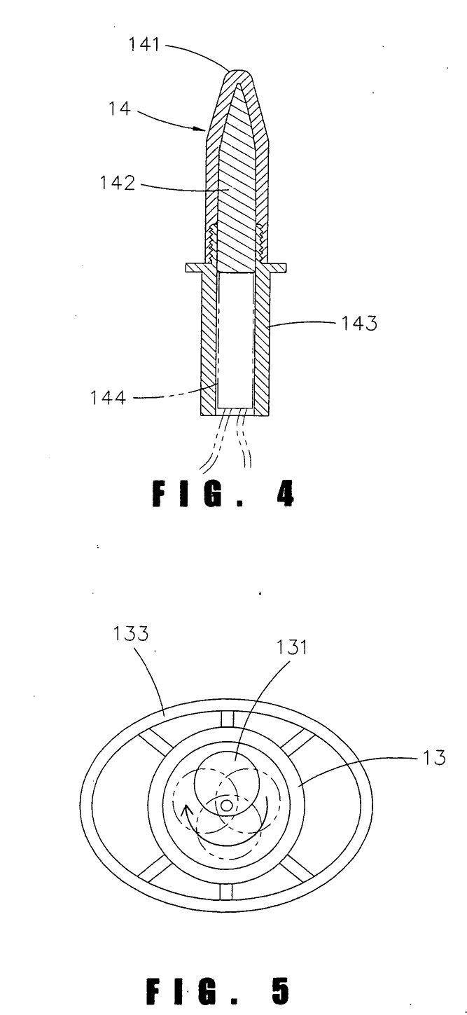

Referring to FIGS. 1 to 5, there is shown a cylindrical massage bar constructed in accordance with a preferred embodiment of the invention. The massage bar comprises a battery compartment 11, a shell assembly 12, a drive unit 13, and a needle unit 14. Each component is discussed in detailed below.

The battery compartment 11 comprises a DC power input 111 at a rear end, the DC power input 111 adapted to releasably electrically connect to a power cord 113 extended from an AC adaptor (not shown), a switch 112 adjacent the DC power input 111 and electrically connected thereto for turning on or off the DC power input 111, and a space 114 adapted to store a cell 20 as an alternative power source when external power is not available through the AC adaptor. The shell assembly 12 comprises an outer shell 121 having a plurality of apertures 121 on its surface, and an inner shell 123 having a plurality of apertures 124 on its surface. These apertures 121 and 124 are adapted to dissipate heat generated by the needle unit 14 within the shell assembly 12 during operation.

The drive unit 13 is disposed in the inner shell 123 and comprises a DC motor (not shown), an eccentric member 131 fixedly connected to a drive shaft of the motor, and a ring 133 fixedly connected to the eccentric member 131. The needle unit 14 is projected through the shell assembly 12 and comprises a pointed end 141, an internal IR (infrared) section 142 fitted in a chamber thereof, the IR section 142 being formed of IR magnetic stone or powder, a rear conductive shell 143, and an electric heating element 144 fitted in the conductive shell 143. The power of the electric heating element 144 is only supplied from the DC power input 111 (i.e., the electric heating element 144 is electrically connected to the DC power input 111).

Referring to FIG. 7, in one use the massage bar is electrically connected to an external AC source through the DC power input 111, the power cord 113, and the AC adaptor. Next, turn on the switch 112 to activate the drive unit 13 (i.e., motor). The ring 133 thus vibrates due to the eccentric rotation of the eccentric member 131. The pointed end 141 of the needle unit 14 also vibrates in response to vibrating the ring 133 for massage. Moreover, the needle unit 14 is activated (i.e., the electric heating element 144 is enabled) to heat the conductive shell 143. And in turn, heat is conducted from the conductive shell 143 to the IR section 142. The energized IR section 142 is adapted to emit IR through the pointed end 141 into parts of the body for carrying out an acupuncture effect.

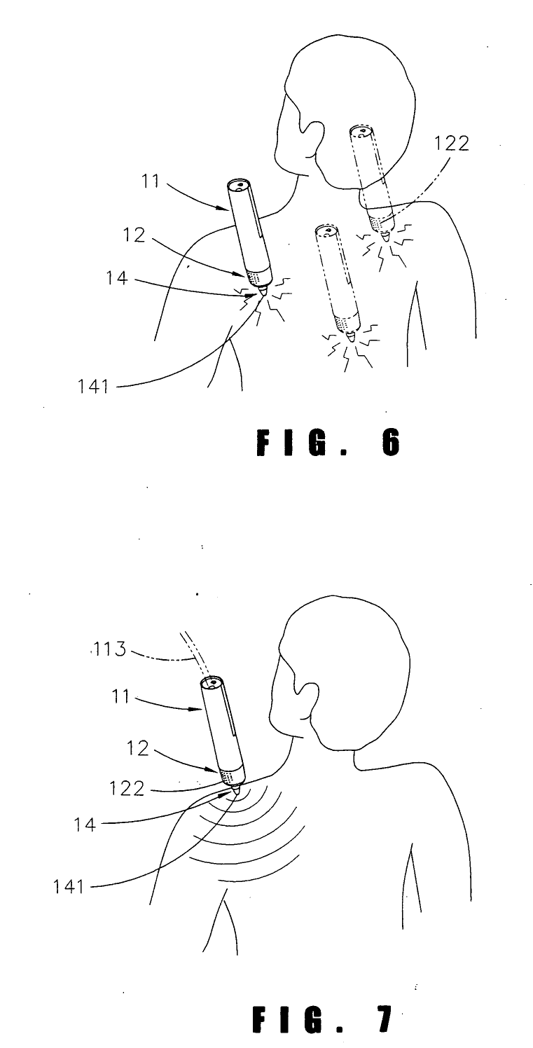

Referring to FIG. 6, in another use three battery operated massage bars are used due to no external AC source available. Likewise, turn on the switch 112 will vibrate the pointed end 141 of the needle unit 14 for massage. But the electric heating element 144 is disabled because power consumed by the electric heating element 144 is much larger than that supplied by the cell 20 during operation. In other words, the acupuncture effect of the IR section 142 is disabled in this use.

While the invention herein disclosed has been described by means of specific embodiments, numerous modifications and variations could be made thereto by those skilled in the art without departing from the scope and spirit of the invention set forth in the claims.

What is claimed is:

1. A massage bar comprising:
a battery compartment comprising a DC power input adapted to releasably electrically connect to an AC adaptor, a switch electrically connected to the DC power input, and a space adapted to store at least one cell;
a shell assembly comprising an outer shell having a plurality of apertures on its surface, and an inner shell having a plurality of apertures on its surface;
a drive unit in the inner shell and comprising a DC motor, an eccentric member fixedly connected to a drive shaft of the DC motor, and a ring fixedly connected to the eccentric member; and
a needle unit projected through the shell assembly and comprising a pointed end, an internal IR section, a conductive shell, and an electric heating element in the conductive shell, the electric heating element being electrically connected to the DC power input;
whereby electrically connecting the massage bar to an external AC source through the DC power input and the AC adaptor and turning on the switch will:
activate the electric heating element to heat the conductive shell for conducting heat to the IR section and causing the IR section to emit IR through the pointed end into parts of the body for carrying out an acupuncture effect; and
activate the drive unit and vibrate the ring and the pointed end for carrying out a massage effect.

2. The massage bar of claim 1, wherein in response to electrically connecting the massage bar to the cell and turning on the switch, the drive unit is activated to vibrate the ring and the pointed end for carrying out a massage effect.

3. The massage bar of claim 1, wherein the IR section is formed of IR magnetic stone.

4. The massage bar of claim 1, wherein the IR section is formed of IR magnetic powder.
